(19) United States
(12) Patent Application Publication
(10) Pub. No.: US 2004/0091029 A1
(43) Pub. Date: May 13, 2004

(54) Data transmission interface

(75) Inventors: Nicholas H. Weiner, Bristol (GB); Benjamin A. Willcocks, Bristol (GB); Paul A. Denny, Bristol (GB); Christopher C. Bryson, Cardiff (GB)

Correspondence Address: LAHIVE & COCKFIELD, LLP., 28 STATE STREET, BOSTON, MA, 02109, US

(73) Assignee: Phyworks Limited, Bristol (GB)

(21) Appl. No.: 10/334,323

(22) Filed: Dec. 30, 2002

(30) Foreign Application Priority Data
Nov. 11, 2002 (GB) 0226246.7

(51) Int. Cl. H04B 1/38; H04L 5/16

(52) U.S. Cl. 375/220; 375/354

(57) ABSTRACT

There is disclosed a method of transferring data from a first device to a second device over parallel connections. The data represents a signal which has some known statistical property, and the data is encoded and distributed between the parallel connections, such that each parallel connection carries a respective time-aligned sequence of bits, and such that the known statistical property of the signal represented by the data is used to establish a known correlation between the respective sequences. In the second device, the known correlation between the respective sequences is used to re-establish time alignment of the received sequences.

The known statistical property of the signal means that the data has some inherent redundancy, and this is used to produce the correlations between the data sequences, which can in turn be used to re-establish time alignment of the sequences in the second device. This can therefore be achieved without needing to increase the amount of data transferred from the first device to the second device.

### TECHNICAL FIELD OF THE INVENTION

This invention relates to a data transmission interface, and in particular to an interface for transmitting output data at high speed from a multi-level quantizer to an error correction device.

### BACKGROUND OF THE INVENTION

In a digital communications system, data bits are transmitted over a communications medium. The waveform which subsequently arrives at the receiver is the transmitted waveform, with the addition of noise, and attenuated and distorted by the communications medium itself.

In order to retrieve transmitted binary data, the receiver may use multi-level quantization, that is, quantization into more than two levels. Thus, for each bit in the received data, a multi-level quantizer provides a code of two or more bits at its output. For example, a four level quantizer provides a two-bit code for each bit in the received data. In this two-bit code, one of the bits may be a polarity bit, which indicates whether the transmitted bit is more likely to have been a 1 or a 0. The second bit may be a confidence bit, which indicates whether a higher or lower degree of confidence can be placed in the polarity bit.

The quantizer outputs are supplied to a decoder, which uses the confidence information to help to correct any errors in the polarity bits. The quantizer may automatically adjust its confidence criteria so that on average, the proportion of low confidence bits remains constant. For example, the decoder might achieve best error correction performance when, on average, 10% of bits are low confidence, and 90% are high confidence.

The quantizer and the decoder may typically be in separate integrated circuits within a receiver, connected by a copper trace connection on a printed circuit board. Moreover, the rate at which data must be transferred from the quantizer to the decoder may be higher than the rate at which data can be transferred over a single copper trace, so that it is necessary to use two or more parallel connections.

Unless the delays through the parallel connections are carefully matched, a synchronisation scheme is required to ensure that the data from the parallel connections are recombined to represent the correct temporal ordering.

The document “Media Access Control (MAC) Parameters, Physical Layer, and Management Parameters for 10 Gb/s Operation”, IEEE P802.3ae/D3.1, section 47, pages 283-296 discloses such a receiver, in which data are transferred from the quantizer to the decoder over parallel copper trace connections on a printed circuit board.

The document “Understanding SONET/SDH and ATM” (Kartalopoulos) pages 80-81 discloses a communication system, in which data are scrambled, that is the data are combined in an exclusive OR (EXOR) operation with a pseudo random binary sequence, before transmission over an optical network, and are then unscrambled, that is the data are combined in an exclusive OR (EXOR) operation with the same pseudo random binary sequence to retrieve the original data, after transmission. This has two effects, namely that the sequence of bits which is transmitted contains effectively equal numbers of 0s and 1s, and that the sequence rarely contains long runs of 0s or 1s. These properties can be utilised in the receiver.

### SUMMARY OF THE INVENTION

According to an aspect of the present invention, there is provided a method of transferring data from a first device to a second device over parallel connections. The data represents a signal which has some known statistical property, and the data is encoded and distributed between the parallel connections, such that each parallel connection carries a respective time-aligned sequence of bits, and such that the known statistical property of the signal represented by the data is used to establish a known correlation between the respective sequences. In the second device, the known correlation between the respective sequences is used to re-establish time alignment of the received sequences.

The known statistical property of the signal means that the data has some inherent redundancy, and this is exploited in the second device to produce the correlations between the data sequences, which can in turn be used to re-establish time alignment of the sequences in the second device. In the preferred embodiments of the invention, this can therefore be achieved without needing any increase the amount of data transferred from the first device to the second device.

According to a second aspect of the present invention, there is provided a method of sampling an analog signal, and encoding and transmitting the data over parallel connections.

According to a third aspect of the invention, there is provided a method of decoding data received over parallel connections.

According to other aspects of the invention, there are provided a system, a quantizer, and a decoder, operating in accordance with the earlier aspects of the invention.

### BRIEF DESCRIPTION OF THE DRAWINGS

FIG. 1 is a block schematic diagram of a communications system including a receiver according to the present invention.

FIG. 2 shows the format of data transferred within a receiver according to the present invention.

FIG. 3 is an enlarged block diagram showing a part of the receiver of FIG. 1.

FIG. 4 shows the format of data transferred within a receiver according to an alternative embodiment of the present invention.

FIG. 5 shows the format of data transferred within a receiver according to a further alternative embodiment of the present invention.

FIG. 6 shows the format of data transferred within a receiver according to a further alternative embodiment of the present invention.

FIG. 7 is a block schematic diagram of an encoder within a receiver according to the present invention.

FIG. 8 shows the format of data output from the encoder of FIG. 7.

FIG. 9 is a block schematic diagram of a decoder within a receiver according to the present invention.

### DETAILED DESCRIPTION OF PREFERRED EMBODIMENTS

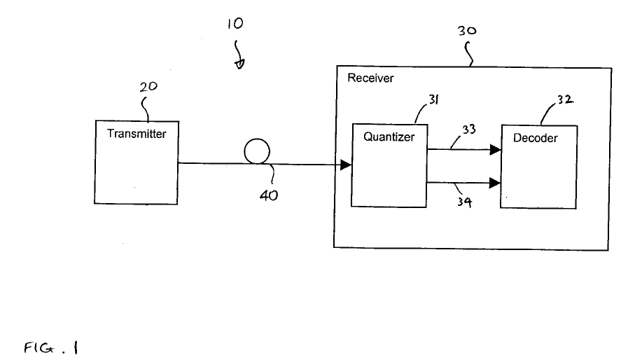

FIG. 1 shows a communication system 10, including a transmitter 20 and a receiver 30.

The transmitter takes input source data, and encodes the source data and converts it into a form which is suitable for transmission to the receiver 30 over a communications medium 40. For example, the communications medium 40 may be an optical fibre.

The source data form a sequence of binary 0s and 1s, and the receiver attempts to recreate that sequence, enabling it to decode the sequence and obtain the source data as its output.

The receiver 30 includes a quantizer 31, which detects the received optical signal, converts the optical signal into an electronic signal, and produces a multi-bit output. Thus, for each bit in the received data, the quantizer 31 provides a code of two or more bits. In this illustrative example, a four level quantizer provides a two-bit code for each bit in the received data. In this two-bit code, one of the bits is a polarity bit, which indicates whether the transmitted bit is more likely to have been a 1 or a 0. The second bit is a confidence bit, which indicates whether a higher or lower degree of confidence can be placed in the polarity bit.

For binary signalling, these bits are obtained by comparing the level of the received signal with appropriate thresholds. A first polarity threshold is set between the expected level of a 1 in the received signal and a 0 in the received signal, and is used to determine the polarity bit. Two further confidence thresholds are defined, one on each side of the first threshold, and are used to determine the value of the confidence bit. That is, if the level of the electronic signal is between the two confidence thresholds, it is determined that a lower degree of confidence can be placed in the polarity bit.

The two further thresholds are set so that most of the confidence bits indicate high confidence. For example, the two confidence thresholds may be set so that the level of the electronic signal is between the two confidence thresholds for 3-10% of the bits. This is done so that the decoder can optimally correct any errors which may occur during transmission of the data. However, the fact that most of the confidence bits indicate high confidence introduces a degree of redundancy into the transmitted data, and the present invention uses that redundancy.

In one illustrative example, a data 0 is used to represent high confidence. The result is that the majority of the confidence bits are 0s.

The quantizer outputs are supplied to a decoder 32, which uses the confidence information to attempt to correct any errors in the polarity bits.

The quantizer 31 and the decoder 32 may typically be in separate integrated circuits within a receiver, connected by copper trace connections on a printed circuit board. Moreover, the rate at which data must be transferred from the quantizer to the decoder may be higher than the rate at which data can be transferred over a single such connection.

Thus, in this illustrated embodiment of the invention, there are two parallel connections 33, 34, which carry respective data sequences representing half of the data to be transferred from the quantizer to the decoder. On receipt at the decoder, however, these two data sequences may no longer be time aligned due to slightly unequal delays in the two parallel connections.

The quantizer 31 therefore includes an encoder interface circuit 35, which converts the data into a specific format, as described further below. This format takes account of the redundancy in the data which are to be transmitted over the two connections, and can be used in the decoder to correct for any time misalignments which may arise between the two data sequences.

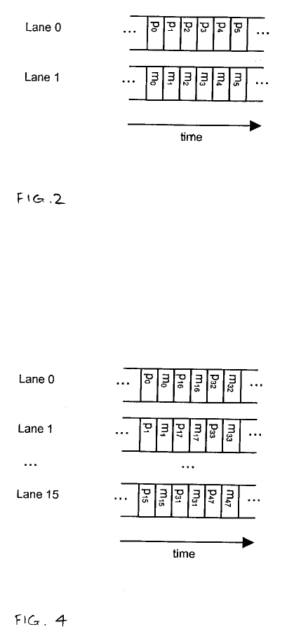

FIG. 2 shows the data sequences which are transferred over the two parallel connections in one embodiment of the invention. The first data sequence, identified as lane 0, contains the polarity bits P₀, P₁, P₂, P₃, . . . , while the second data sequence, identified as lane 1, carries the confidence information. However, the representation of confidence bits C₀, C₁, C₂, C₃, . . . , is modified before transmission. Specifically, each confidence bit Cₙ is combined in an XOR operation with the corresponding polarity bit Pₙ to give a modified representation Mₙ=Cₙ XOR Pₙ.

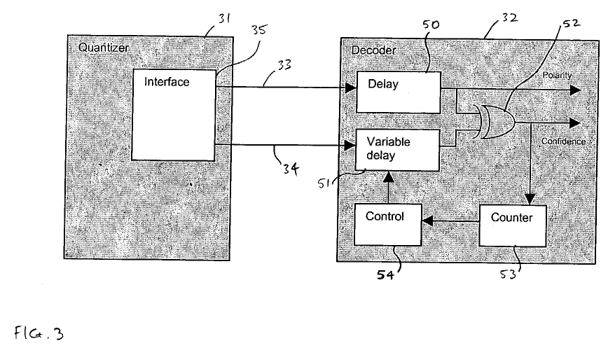

FIG. 3 is a block schematic diagram showing in more detail a part of the receiver 30 shown in FIG. 1.

Specifically, FIG. 3 shows the quantizer 31 and the encoder interface circuit 35, which converts the data into the specific format described above.

The specific format is such that the decoder 32 can correct for any time misalignments between the two data sequences, which might be introduced by the two connections 33, 34. The decoder 32 includes a first delay element 50, which receives the data from one of the connections, in this case the connection 33, and a second variable delay element 51, which receives the data from the other connection, in this case the connection 34.

The outputs from the two delay elements 50, 51 therefore comprise one data sequence made up of the transmitted polarity bits, plus one data sequence made up of the transmitted modified confidence bits, with an unknown time misalignment between the two data sequences. These two outputs are supplied to an XOR gate 52, and the resulting bits are monitored by a counter 53, which determines the proportion of 1s and 0s in the sequence. The counter 53 supplies an input to a control circuit 54, which scans through different settings of the variable delay element 51.

When the delay setting of the variable delay element 51 is such that the two received sequences are correctly aligned, the effect of the XOR operation in the XOR gate 52 is to cancel the XOR modification of the confidence bits which took place in the quantizer interface circuit 35. In that case, the output of the XOR gate 52 is the original sequence of confidence bits, in which, as noted previously 0s predominate by a significant margin (this assumes 0 represents high confidence). When the delay setting of the variable delay element 51 is such that the two received sequences are not correctly aligned, the effect of the XOR operation in the XOR gate 52 is to produce a data sequence which comprises equal numbers of 1s and 0s.

The counter 53 can therefore detect when the time alignment is correct, and can ensure that the delay setting of the variable delay element 51 maintains the correct time alignment. Since this is a statistical measurement, the reliability of the decision increases as the measurement period increases. The time taken to detect alignment can therefore be balanced against the probability of incorrectly detecting alignment.

In this way, the redundancy in the transmitted data, i.e. the statistical knowledge about the transmitted data, can be used to correct any time misalignments between the data sequences.

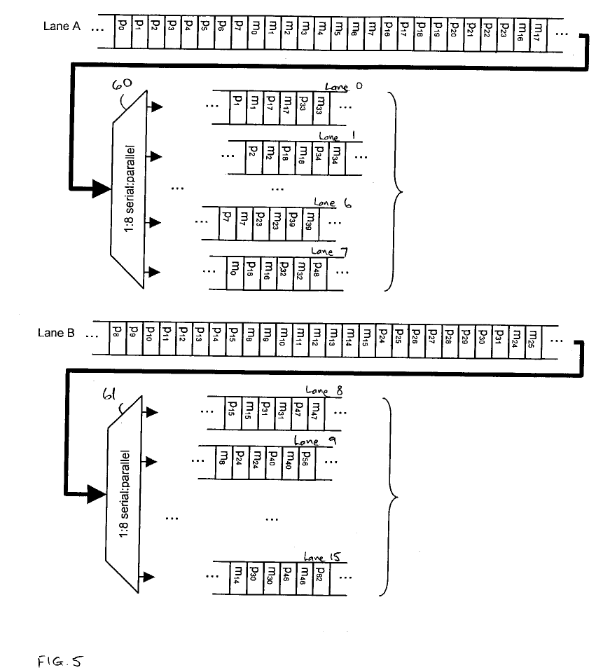

The invention is applicable to interfaces comprising any number of lanes. For example, FIG. 4 shows the format of the transmitted data in the case of a 16 lane connection between the quantizer and the decoder. In this case, each data sequence comprises alternating polarity bits and modified confidence bits. The sequence of polarity bits P₀, P₁, P₂, P₃, . . . , is transmitted with polarity bit Pₙ in lane n for 0≧n≧15, in lane (n-16) for 16≦n≦31, etc. The representation of confidence bits C₀, C₁, C₂, C₃, . . . , is modified before transmission to give a sequence of modified confidence bits M₀, M₁, M₂, M₃, . . . . In the preferred embodiment, each modified confidence bit Mₙ is transmitted in the same lane as, and immediately following, the associated polarity bit Pₙ, although other formats are also possible. In the modification, the confidence bits are encoded by XORing them with their associated polarity bits, and with polarity bits from a neighbouring lane. Specifically, each modified confidence bit Mₙ=Cₙ XOR Pₙ XOR Pₙ₋₁.

In this case, the decoder is somewhat similar to that shown in FIG. 3, but includes a variable delay element for each connection except lane 0. The variable delay for lane 1 is adjusted until alignment with lane 0 is detected; the variable delay for lane 2 is then adjusted until alignment with lane 1 is detected, and so on until all 16 lanes are correctly time aligned. Additionally, if the lanes are connected in an unknown order, it is possible to deduce the order at the receiver by XORing the data received on one connection with the data sequences received on the other lanes, since the confidence bits on a given lane will only be decoded correctly when XORed with polarity bits from the correct neighbouring lane.

FIG. 5 shows an arrangement in which this latter property is useful. In this arrangement, the data is first transmitted over two parallel connections, identified as lane A and lane B, and then the data on each of these two connections is demultiplexed in a respective 1:8 serial:parallel converter 60, 61 onto eight separate lanes, making sixteen parallel connections in total. Thus the data on lane A are transferred onto lanes 0-7, and the data on lane B are transferred onto lanes 8-15.

In this case, the data sequences on lanes A and B each comprise alternating blocks of polarity bits and modified confidence bits. The block of polarity bits P₀-P₇ is transferred on lane A, the block P₈-P₁₅ is transferred on lane B, the block P₁₆-P₂₃ is transferred on lane A, etc. The sequence of confidence bits C₀, C₁, C₂, C₃, . . . , is modified before transmission to give a sequence of modified confidence bits M₀, M₁, M₂, M₃, . . . , and the modified confidence bits are transferred in blocks in the same way as the polarity bits. Thus, the block of modified confidence bits M₀-M₇ is transferred on lane A immediately after the polarity bits P₀-P₇, the block M₈-M₁₅ is transferred on lane B immediately after the block P₈-P₁₅, the block M₁₆-M₂₃ is transferred on lane A immediately after the block P₁₆-P₂₃, etc.

In the serial:parallel converter 60, the data on lane A are transferred onto lanes 0-7, but the serial:parallel converter is such that the lane order is arbitrarily rotated. That is, FIG. 5 shows data bit P₀ on lane 7, and data bits P₁-P₇ on lanes 0-6 respectively, but data bit P₀ might in fact appear on any of lanes 0-7. Similarly, FIG. 5 shows data bit P₈ on lane 9, in which case data bits P₉-P₁₄ would appear on lanes 10-15 respectively, and data bit P₁₅ would appear on lane 8, but data bit P₈ might in fact appear on any of lanes 8-15. Because the data is transferred on lanes A and B in blocks of eight polarity bits followed by eight modified confidence bits, each of the modified confidence bits Mₙ is transmitted in the same lane as, and immediately following, the associated polarity bit Pₙ. The modification is achieved by XORing the confidence bits with their associated polarity bits, and with the respective preceding polarity bits. Specifically, each modified confidence bit Mₙ=Cₙ XOR Pₙ XOR Pₙ₋₁.

As before, lanes A and B, and lanes 0-15 introduce time delays which are not necessarily matched with each other, so that time misalignments can occur between the data sequences on the different connections.

In this case, the decoder acts in a way which is similar to that described above. The data received on one connection are XORed with the data sequences received on the adjacent lanes, assuming different time misalignments, and also assuming different starting lanes (that is, lanes to which data bits P₀ and P₈ are assigned). The confidence bits will only be decoded correctly when these have been resolved. The entire original data sequence can then be reconstructed.

Again, the invention uses the redundancy in the transmitted data, in the form of statistical information about at least some of the data contents, to correct for time misalignments on the different parallel connections. In the examples described above, this is achieved by combining the confidence bits, about which this statistical information is known, with polarity bits which are transmitted over different connections.

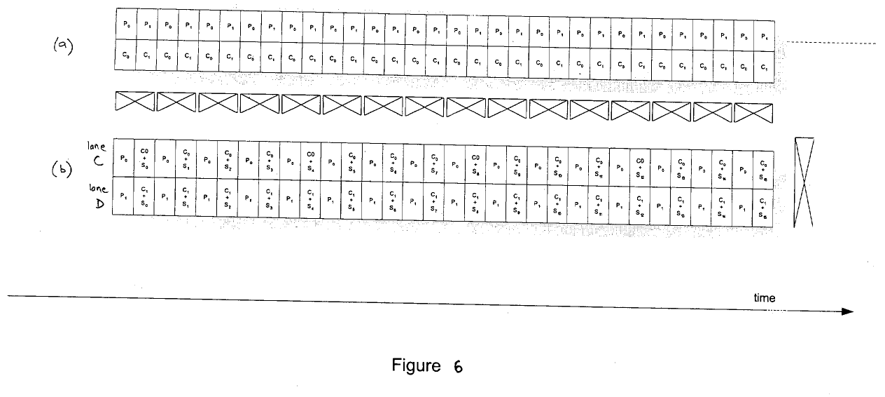

FIGS. 6-9 show other examples of how this principle can be applied, again in systems of the general type shown in FIG. 1.

FIG. 6(a) shows the output from the quantizer, which contains one polarity bit in each bit period of the optical channel 40, the polarity bits being alternately designated P₀ and P₁, and also contains one confidence bit in each bit period of the optical channel 40, the confidence bits being alternately designated C₀ and C₁.

In the encoder interface circuit 35, the polarity and confidence bits are divided into two sequences, for transmission over the two parallel connections, or lanes. Each sequence contains polarity and confidence bits in a known order. For example, in this illustrated embodiment, FIG. 6(b) shows the encoder outputs on the two lanes, indicated in this case as lane C and lane D, with polarity and confidence bits alternating within each sequence.

Moreover, the confidence bits are scrambled. That is, they are combined in a bitwise exclusive OR operation with scrambling bits S₁, S₂, S₃, . . . from a known pseudo random binary sequence.

It should be noted that the two confidence bits C₀, C₁, transmitted on the two lanes during one time slot are scrambled with the same scrambling bit. In the case where a large majority of confidence bits indicate high confidence, this means that, in most cases, the two confidence bits transmitted during one time slot are the same.

Thus, each of the two sequences shown in FIG. 6(b) contains two interleaved sub-sequences, one of the sub-sequences containing polarity bits, and the other containing scrambled confidence bits. The sequences are then transmitted over the two lanes of the circuit board connection to the decoder circuit 32.

On receipt at the interface circuit 36 of the decoder 32, the initial time alignment between the two sequences may have been lost. However this arrangement allows the time alignment to be recovered. Since the confidence bits contain mostly 0s, the scrambled confidence bits in each sequence approximate to the scrambling sequence.

Therefore by comparing the received data sequences, it is possible to identify which are the scrambled confidence bits, and also to recover the initial time alignment between the sequences.

Further, the original confidence information can be recovered by unscrambling the scrambled information, by combining it in a bitwise XOR operation with the known pseudo random binary sequence.

More specifically, the decoder 36 uses the assumption that the majority of confidence bits are 0s, and hence that the majority of confidence bit slots will contain the scrambling bit. Moreover, when the lane sequences are correctly aligned, the scrambled confidence bits mostly have the same value.

Therefore, the decoder interface circuit 36 takes the two received sequences from the pair of lanes, and applies a number of periods of latency (which may be negative, zero and positive) between them, corresponding to possible time misalignments between the received sequences. A first of these periods of latency is applied, and then, for each of the two interleaves (each comprising one sub-sequence of alternate bits), the decoder interface 36 computes the proportion of time slots during which the two lanes match.

If one of the two interleaves exhibits a high proportion of matching bits (higher than, say, 75%) between the two sequences, then it can be assumed that the two lanes are correctly aligned. Further, the sub-sequence which exhibits the matching is the one that contains the scrambled confidence bits.

If neither of the two interleaves exhibits the specified high proportion of matching bits, the lanes are not correctly aligned. In that case, the next possible period of latency is applied.

In this way, the two lanes may be correctly aligned and the two different interleaves (polarity and confidence) identified.

Once the lanes are correctly aligned, the received (scrambled) confidence bits in the two lanes will match during the majority of confidence bit interleave slots. The pseudo random binary sequence generator at the receiver may be synchronized by finding a run of scrambled confidence bits that mismatch on at most, say, two occasions. When the two scrambled confidence bits match, this is most likely because the two confidence bits were both 0s, and the scrambling bit is likely to be equal to the two scrambled confidence bits. When the two scrambled confidence bits mismatch, the scrambling bit could be either 1 or 0. This means that a sequence including two mismatches allows four different possible seed patterns to be identified. Using four different pseudo random binary sequence generators, these four possible seed patterns can all be tried, and the pattern retained that continues to match the majority of scrambled confidence bits in the relevant sub-sequences.

As described above, the time alignment of the lanes is restored, and the scrambling sequence is then deduced so that the original confidence bits can be recovered.

Alternatively, the scrambling sequence may be deduced first, for each of the lanes. This can be achieved by determining which interleave in a lane has the closest correlation with the known scrambling sequence, and the time alignment which produces this correlation. Once this has been established separately for each lane, the time alignment of the lanes can easily be restored.

FIG. 6 relates to a system in which data is transferred from the quantizer device to the decoder device over two parallel lanes. However, the invention is also applicable to transferring data over a larger number of parallel lanes.

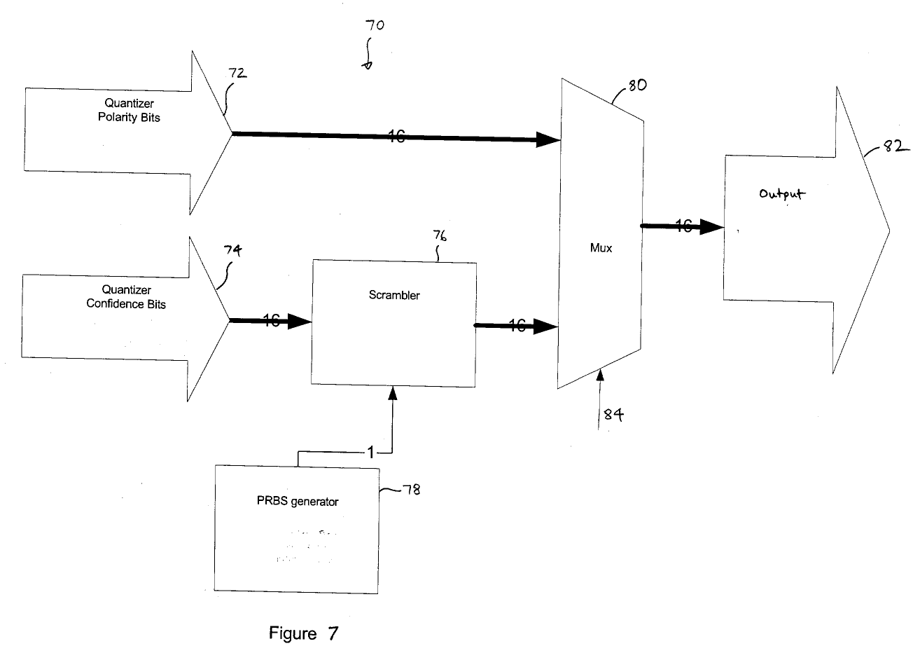

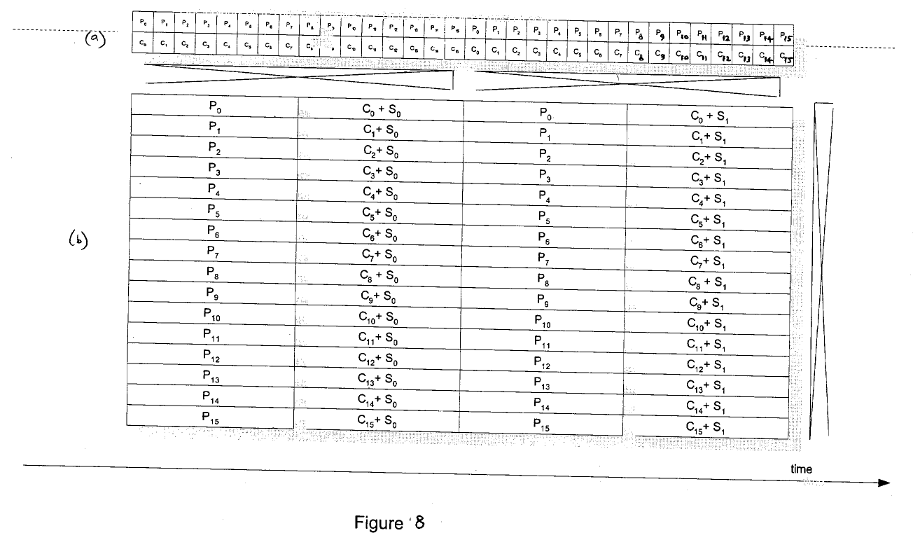

For example, FIG. 7 shows the form of an encoder interface circuit for use in the case where there are 16 parallel lanes between the quantizer device and the decoder device. This allows the data rate on each of the lanes to be lower, or allows a higher overall data rate to be used. FIG. 8 shows the format of the data transferred over the 16 parallel lanes in this case.

As before, the output from the quantizer, shown in FIG. 8(a), contains one polarity bit and one confidence bit in each bit period of the optical channel 40. The polarity bits are sequentially designated P₀, P₁, P₂, P₃, . . . , P₁₅, P₀, etc, and the respective confidence bits are correspondingly sequentially designated C₀, C₁, C₂, C₃, . . . , C₁₅, C₀, etc.

In the encoder interface circuit 70 of FIG. 7, the polarity bits from the quantizer are received on a 16 bit parallel connection 72. Since one polarity bit is received for each bit on the optical channel 40, the data on the parallel connection 72 is updated at one-sixteenth of the data rate on the optical channel 40. Similarly, the confidence bits from the quantizer are received on a 16 bit parallel connection 74. Since there is also one confidence bit for each bit on the optical channel 40, the data on the parallel connection 74 is updated at the same rate as the data on the parallel connection 72.

The data on the parallel connection 74 is supplied to a scrambler 76, which is also connected to a pseudo random binary sequence generator 78. The pseudo random binary sequence generator 78 generates a sequence of bits derived from a specific polynomial. The bits of the sequence are generated at the same rate at which data on the parallel connection 74 is updated, and all sixteen confidence bits on the parallel connection 74 are combined in a bitwise exclusive OR operation with the one current bit of the pseudo random binary sequence.

The polarity bits on the parallel connection 72, and the scrambled confidence bits output from the scrambler 76, are supplied to a multiplexer (Mux) 80, which has a 16 lane output 82. A control signal 84 determines whether the multiplexer 80 passes the polarity bits or the scrambled confidence bits to its output 82. The control signal operates such that each lane contains a polarity bit, followed by its associated scrambled confidence bit, followed by a further polarity bit and then its associated scrambled confidence bit, etc.

Thus, as shown in FIG. 8, lane n (0≦n≦15) of the output 82 contains, in a first time period a polarity bit Pₙ, in a second time period a confidence bit Cₙ scrambled with a first scrambling bit S₀, in a third time period the next polarity bit designated Pₙ, in a fourth time period the next confidence bit designated Cₙ scrambled with a second scrambling bit S₁, etc. Thus, each lane of the output 82 transfers data at twice the rate at which the data on the parallel connection 72 is updated, that is, one eighth of the data rate on the optical channel 40.

The data on the output 82 are then transferred from the quantizer chip to the decoder interface circuit of the decoder chip by means of the sixteen lane connection on the printed circuit board.

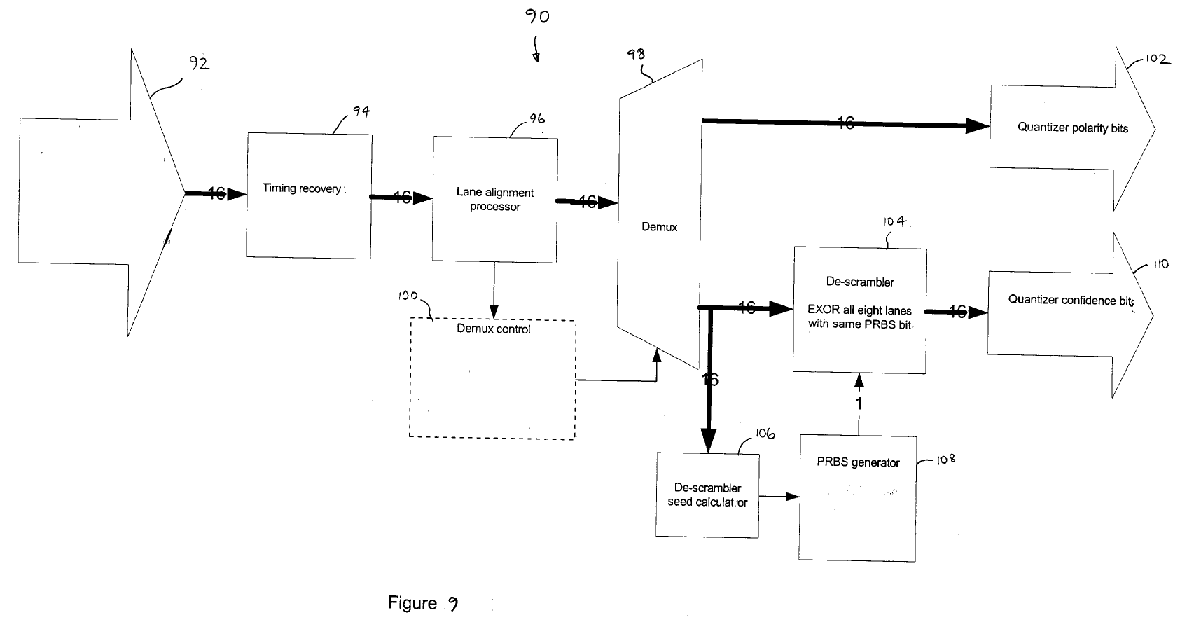

FIG. 9 shows the decoder interface circuit 90, which receives the data transferred from the quantizer chip on its input 92. After this transfer, the time alignment between the data on the different lanes may have been lost, and the circuit 90 acts to restore this alignment, and recover the original quantizer output data. The data received in the circuit 90 are passed to a timing recovery block 94, which determines the relative timings of the sixteen lanes, including any misalignments introduced during the transfer.

The data is then passed to a lane alignment processor 96, which calculates the magnitudes of the misalignments between the lanes, and also determines which data represent polarity bits and which represent confidence bits.

More specifically, the processor 96 uses the assumption that the majority of confidence bits are zero, and hence that the majority of confidence bit slots will contain the scrambling bit. Moreover, when the lane sequences are correctly aligned, the scrambled confidence bits mostly have the same value.

Therefore, the processor 96 takes the two received sequences from any pair of lanes, and applies a number of periods of latency (which may be negative, zero and positive) between them, corresponding to possible time misalignments between the received sequences. A first of these periods of latency is applied, and then, for each of the two interleaves (each comprising one sub-sequence of alternate bits), the processor 96 computes the proportion of time slots during which the two lanes match.

If one of the two interleaves exhibits a high proportion of matching bits (higher than, say, 75%) between the two sequences, then it can be assumed that the two lanes are correctly aligned. Further, the sub-sequence which exhibits the matching is the one that contains the scrambled confidence bits.

If neither of the two interleaves exhibits the specified high proportion of matching bits, the lanes are not correctly aligned. In that case, the next possible period of latency is applied.

In this way, the two lanes may be correctly aligned and the two different interleaves (polarity and confidence) identified.

Then, the same technique can be applied to eventually align all sixteen lanes, and to identify in each case which interleave contains polarity bits and which confidence bits.

The interleaved data are output from the lane alignment processor 96 to a demultiplexer 98, which operates under the control of a demultiplexer controller 100. The demultiplexer controller 100 itself receives an output from the lane alignment processor 96 and, on the basis thereof, it controls the demultiplexer such that the sub-sequence of polarity bits is provided on the output 102. Meanwhile, the sub-sequence of scrambled confidence bits is directed to a descrambler 104, and to a descrambler seed calculator 106.

The data rate on the output 102 and the data rate supplied to the descrambler 104 are each half of the data rate received on the input 92.

Once the lanes are correctly aligned, the received (scrambled) confidence bits will match for most of the lanes during most confidence bit interleave slots. The descrambler seed calculator 106 therefore takes a majority vote across the sixteen lanes, and this will almost always yield the correct scrambling bit value.

The computed descrambler seed is supplied to a pseudo random binary sequence generator 108, which recreates the originally used sequence, from the computed descrambler seed, generating one bit for sixteen bit set of scrambled confidence data.

The recreated pseudo random binary sequence is then supplied to the descrambler 104, and the data in all sixteen lanes is descrambled, that is, combined in an exclusive OR operation with the corresponding bit of the recreated pseudo random binary sequence.

The correctness of the computed descrambler seed can be confirmed as descrambling progresses, as the majority vote across the scrambled confidence bits should continue to match the descrambler code in almost all cases.

The descrambled confidence bits are then output on line 110, in parallel with the associated polarity bits, for further processing (for example, error correction) in the decoder circuit.

As described above, the time alignment of the lanes is restored, and the scrambling sequence is then deduced so that the original confidence bits can be recovered.

Alternatively, the scrambling sequence may be deduced first, for each of the lanes. This can be achieved by determining which interleave in a lane has the closest correlation with the known scrambling sequence, and the time alignment which produces this correlation. Once this has been established separately for each lane, the time alignment of the lanes can easily be restored.

Again, therefore, this system uses the redundancy in the transmitted data, in the form of statistical information about the confidence bits, to correct for time misalignments on the different parallel corrections. In these latter examples, this is achieved by combining the confidence bits, which are transmitted over different connections, with bits from a known sequence.

Other methods exist for using the same principle. For example, the use of pseudo random binary sequences is mentioned above, but any sequences which have a known relationship can be used. The required effect can also be achieved by combining the confidence bits, which are transmitted over different connections, with bits from different known sequences, provided that the relationship between the sequences was also known.

Methods are therefore described herein for transferring data in the form of polarity and confidence bits. Although the invention has been described with reference to systems in which there is one confidence bit associated with each polarity bit, it is also applicable to systems in which there are multiple confidence bits associated with each polarity bit. The same principle can also be applied to other systems in which the data include symbols made up of multiple bits, such as multi-level signalling or multi-phase/multi-amplitude carrier modulation methods.

1. A method of transferring data from a first device to a second device over parallel connections, wherein the data represents a signal which has some known statistical property, the method comprising:
in the first device:
encoding the data and distributing the encoded data between the parallel connections, such that each parallel connection carries a respective time-aligned sequence of bits, and such that the known statistical property of the signal represented by the data is used to establish a known correlation between the respective sequences; and
in the second device:
receiving the transmitted bits;
using the known correlation between the respective sequences to re-establish time alignment of the received sequences; and
decoding the encoded data.

2. A method as claimed in claim 1, wherein the data comprises quantizer output data made up of polarity bits and confidence bits, and the known statistical property of the quantizer output data is the proportion of the confidence bits representing different confidence levels.

3. A method as claimed in claim 2, further comprising:
encoding the quantizer output data by combining the sequence of confidence bits with a sequence of polarity bits.

4. A method as claimed in claim 3, comprising
combining each bit in the sequence of confidence bits with an associated bit in the sequence of polarity bits; and
transmitting the sequence of polarity bits and the encoded sequence of confidence bits over respective parallel connections.

5. A method as claimed in claim 3, comprising
combining each bit in the sequence of confidence bits with an associated bit in the sequence of polarity bits and with another bit at a known relative position in the sequence of polarity bits; and
transmitting respective sequences of polarity bits and associated confidence bits over respective parallel connections.

6. A method as claimed in claim 2, further comprising:
encoding the quantizer output data by combining the sequence of confidence bits with bits from one or more known sequences of bits.

7. A method as claimed in claim 6, further comprising:
transmitting the encoded confidence bits over a plurality of said parallel connections, one of the confidence bits transmitted on each of the connections having been combined with the same bit from a known sequence of bits.

8. A method as claimed in claim 6, further comprising:
transmitting the encoded confidence bits over a plurality of said parallel connections, wherein the confidence bits transmitted on each of the connections have been combined with bits from respective known sequences of bits with a known relationship between the known sequences.

9. A method as claimed in claim 1, wherein the data comprises a sequence of multi-bit quantized representations of a sampled signal.

10. A method as claimed in claim 9, wherein the multi-bit quantized representations of the sampled signal are two-bit quantized representations of the sampled signal.

11. A method as claimed in claim 10, wherein the data comprises one polarity bit and one confidence bit for each sample.

12. A method as claimed in claim 9, wherein the data comprises a multiple-bit symbol representing each sample.

13. A method of transferring data from a first device to a second device over parallel connections, the method comprising:
sampling an analog signal, and comparing the sampled analog values with a plurality of threshold values to obtain a sequence of multi-bit quantized representations of the analog signal, wherein the threshold values are set such that the resulting data has some known statistical property;
encoding the data and distributing the encoded data between the parallel connections, such that each parallel connection carries a respective time-aligned sequence of bits, and such that the known statistical property of the data is used to establish a known correlation between the respective sequences.

14. A method as claimed in claim 13, wherein the analog signal represents a binary signal after it has been received over a communications medium, and wherein the threshold values are set such that each multi-bit quantized representation of the analog signal comprises one polarity bit and one confidence bit.

15. A method as claimed in claim 14, wherein the threshold values are set such that a majority of confidence bits indicate high confidence.

16. A method as claimed in claim 14, further comprising:
encoding the data by combining the sequence of confidence bits with a sequence of polarity bits.

17. A method as claimed in claim 16, comprising
combining each bit in the sequence of confidence bits with an associated bit in the sequence of polarity bits; and
distributing the sequence of polarity bits and the encoded sequence of confidence bits to respective parallel connections.

18. A method as claimed in claim 16, comprising
combining each bit in the sequence of confidence bits with an associated bit in the sequence of polarity bits and with another bit at a known relative position in the sequence of polarity bits; and
distributing respective sequences of polarity bits and associated confidence bits over respective parallel connections.

19. A method as claimed in claim 14, further comprising:
encoding the data by combining the sequence of confidence bits with bits from one or more known sequences of bits.

20. A method as claimed in claim 19, further comprising:
distributing the encoded confidence bits between a plurality of said parallel connections, one of the confidence bits transmitted on each of the connections having been combined with the same bit from a known sequence of bits.

21. A method as claimed in claim 19, further comprising:
distributing the encoded confidence bits between a plurality of said parallel connections, wherein the confidence bits transmitted on each of the connections have been combined with bits from respective known sequences of bits with a known relationship between the known sequences.

22. A method of decoding data transferred from a first device to a second device over parallel connections, wherein the data represents a signal which has some known statistical property, and the data has been encoded and distributed between the parallel connections, such that each parallel connection carries a respective time-aligned sequence of bits, and such that the known statistical property of the signal represented by the data is used to establish a known correlation between the respective sequences;
the method comprising, in the second device:
receiving the transmitted bits;
using the known correlation between the respective sequences to re-establish time alignment of the received sequences; and
decoding the encoded data.

23. A method as claimed in claim 22, wherein the data comprises quantizer output data made up of polarity bits and confidence bits, and the known statistical property of the quantizer output data is the proportion of the confidence bits representing different confidence levels.

24. A method as claimed in claim 23, wherein the data is encoded by combining each bit in the sequence of confidence bits with an associated bit in the sequence of polarity bits; and transmitting the sequence of polarity bits and the encoded sequence of confidence bits over respective parallel connections,
the method comprising determining a time-alignment which produces a high degree of correlation between the received sequence of polarity bits and the received encoded sequence of confidence bits; and
decoding the data by combining each bit in the sequence of encoded confidence bits with the associated bit in the sequence of polarity bits.

25. A method as claimed in claim 23, wherein the data was encoded by combining each bit in the sequence of confidence bits with an associated bit in the sequence of polarity bits and with another bit at a known relative position in the sequence of polarity bits; and transmitting respective sequences of polarity bits and associated confidence bits over respective parallel connections,
the method comprising combining respective bits from the sequences received over the respective parallel connections to determine a correct time alignment between them; and
decoding the data by combining each bit in the sequence of encoded confidence bits with the associated bit in the sequence of polarity bits and with the other bit at the known relative position in the sequence of polarity bits.

26. A method as claimed in claim 23, wherein the data was encoded by combining the sequence of confidence bits with bits from one or more known sequences of bits,
the method comprising determining a correct time alignment of the received data by finding received bits having a high correlation with said one or more known sequences of bits, and
decoding the data by combining the encoded sequence of confidence bits with bits from the one or more known sequences of bits.

27. A system for transferring data, comprising:
a first device;
a second device; and
a plurality of parallel connections from the first device to the second device,
wherein the data represents a signal which has some known statistical property,
the first device being suitable for:
encoding the data and distributing the encoded data between the parallel connections, such that each parallel connection carries a respective time-aligned sequence of bits, and such that the known statistical property of the signal represented by the data is used to establish a known correlation between the respective sequences; and
the second device being suitable for:
receiving the transmitted bits;
using the known correlation between the respective sequences to re-establish time alignment of the received sequences; and
decoding the encoded data.

28. A system as claimed in claim 27, wherein the data comprises quantizer output data made up of polarity bits and confidence bits, and the known statistical property of the quantizer output data is the proportion of the confidence bits representing different confidence levels.

29. A system as claimed in claim 27, wherein the first device is suitable for:
encoding the quantizer output data by combining the sequence of confidence bits with a sequence of polarity bits.

30. A system as claimed in claim 27, wherein the data comprises a sequence of multi-bit quantized representations of a sampled signal.

31. A quantizer, for sampling an analog signal, and comparing the sampled analog values with a plurality of threshold values to obtain a sequence of multi-bit quantized representations of the analog signal, wherein the threshold values are set such that the resulting data has some known statistical property, the quantizer further comprising encoding circuitry, for encoding the data and distributing the encoded data between the parallel connections, such that each parallel connection carries a respective time-aligned sequence of bits, and such that the known statistical property of the data is used to establish a known correlation between the respective sequences.

32. A quantizer as claimed in claim 31, wherein the analog signal represents a binary signal after it has been received over a communications medium, and wherein the threshold values are set such that each multi-bit quantized representation of the analog signal comprises one polarity bit and one confidence bit.

33. A quantizer as claimed in claim 32, wherein the threshold values are set such a majority of confidence bits indicate high confidence.

34. A quantizer as claimed in claim 32, wherein the encoding circuitry is adapted to encode the data by combining the sequence of confidence bits with a sequence of polarity bits.

35. A quantizer as claimed in claim 34, wherein the encoding circuitry is adapted to encode the data by combining each bit in the sequence of confidence bits with an associated bit in the sequence of polarity bits; and distribute the sequence of polarity bits and the encoded sequence of confidence bits to respective parallel connections.

36. A quantizer as claimed in claim 34, wherein the encoding circuitry is adapted to encode the data by combining each bit in the sequence of confidence bits with an associated bit in the sequence of polarity bits and with another bit at a known relative position in the sequence of polarity bits; and distribute respective sequences of polarity bits and associated confidence bits over respective parallel connections.

37. A quantizer as claimed in claim 33, wherein the encoding circuitry is adapted to encode the data by combining the sequence of confidence bits with bits from one or more known sequences of bits.

38. A quantizer as claimed in claim 37, wherein the encoding circuitry is adapted to distribute the encoded confidence bits between a plurality of said parallel connections, one of the confidence bits transmitted on each of the connections having been combined with the same bit from a known sequence of bits.

39. A quantizer as claimed in claim 37, wherein the encoding circuitry is adapted to distribute the encoded confidence bits between a plurality of said parallel connections, wherein the confidence bits transmitted on each of the connections have been combined with bits from respective known sequences of bits with a known relationship between the known sequences.

40. A decoder, for decoding data transferred from a quantizer to said decoder over parallel connections, wherein the data represents a signal which has some known statistical property, and the data has been encoded and distributed data between the parallel connections, such that each parallel connection carries a respective time-aligned sequence of bits, and such that the known statistical property of the signal represented by the data is used to establish a known correlation between the respective sequences;
wherein the decoder is adapted to:
receive the transmitted bits;
use the known correlation between the respective sequences to re-establish time alignment of the received sequences; and
decode the encoded data.
